(19) United States
(12) Patent Application Publication
(10) Pub. No.: US 2020/0384729 A1
(43) Pub. Date: Dec. 10, 2020

(54) REPOSITIONABLE WATERCRAFT TRACTION PAD

(71) Applicant: Aidan Gray, Pacific Palisades, CA (US)

(72) Inventor: Aidan Gray, Pacific Palisades, CA (US)

(21) Appl. No.: 16/896,162

(22) Filed: Jun. 8, 2020

Related U.S. Application Data
(60) Provisional application No. 62/858,976, filed on Jun. 7, 2019.

(51) Int. Cl. B32B 7/06; B32B 7/12; B32B 7/08; B32B 3/30; B32B 3/06; B32B 7/022; A44B 18/00; B63B 32/50

(52) U.S. Cl. CPC B32B 7/06; B32B 7/12; B32B 7/08; B32B 3/30; B32B 3/06; B32B 2471/04; A44B 18/0073; B63B 32/50; B32B 2605/00; B32B 2475/00; B32B 7/022

(57) ABSTRACT

A watercraft board traction system includes a base layer having a upper surface and a bottom surface, the bottom surface of the base layer including an adhesive layer configured to adhesively attach to the board. The system further includes a traction layer having an upper surface and a bottom surface, the upper surface of the traction layer having a plurality of traction elements. The system further includes a fastener system having a bottom portion coupled with the upper surface of the base layer and a top portion coupled with the bottom surface of the traction layer, the fastener system being configured to releasably fasten the traction layer to the base layer when the base layer is adhesively attached to the board, the fastener system enabling repositioning and/or reorienting the traction layer relative to the base layer when the traction layer is fastened to the base layer.

### CROSS-REFERENCE TO RELATED APPLICATIONS

This application claims the benefit of U.S. Provisional Application No. 62/858,976, filed Jun. 7, 2019. This application is incorporated herein by reference in its entirety.

### BACKGROUND

Traction pads for watercraft boards such as surfboards, stand-up paddle boards (SUPs), boogie boards, skim boards, hydrofoil boards, and more serve the purpose of providing a surface with more traction or grip for a person's feet than the surface of the board or even wax on the surface can provide. Traction pads are most often applied to the tail, or back, of a board, to provide traction to a rider's rear foot, but can also be applied to the mid-section or front of the board, to provide traction to the rider's front foot.

Traction pads can include one or more of a tail kick, an arch, several pieces, and traction elements. The tail kick is a section of the top of the traction pad that rises up from the top surface and typically across a rear edge of the traction pad. The tail kick can be engaged by a backward force of the rider's rear foot for controlling or manipulating movement of the rear section of the board. The arch is usually an elongated bump along a longitudinal axis of the traction pad to accommodate an arch of the rider's rear foot. Traction pads can be formed as a unitary, planar pad, or can be formed in two or more sections for greater flexibility in applying the traction pad(s) to the board. The traction elements can include any number of grooves, bumps, raised textures, channels, ridges, protuberances, knobs, bulges, channels, cuts, indentations, or the like, to provide texture and traction on which the rider's foot can grip.

Tractions pads are traditionally made out of a flexible and compressible foam, such as ethylene-vinyl acetate (EVA) foam, and can include surfaces of any size and texture patter. However, there has been an effort to use more environmentally-friendly materials, such as plasticized or polymerized algae, certain weeds, or other organic materials.

Conventional traction pads are applied, and stuck, to a board with a one-time-use adhesive glue, which rigidly affixes the traction pad to the board. The conventional thought for the use of this sort of adhesive method is that it is the only way to provide the support and strength to keep the traction pad in its exact initial-desired position, and to negate any movement once applied and adhered to the board. The function of complete sturdiness that such adhesives provide is what is typically desired in traction pads. In other words, once these traction pads are in use on a board, the user does not want there to be any movement of the traction pad in a horizontal plane relative to the board, for both performance and safety reasons. Thus, a permanent adhesive has typically, and singularly, been considered standard for traction pads in order to realize their full functionality.

However, while permanent adhesives work well for applying traction pads, they have their problems and limitations. For instance, a surfer may want to change a position, surface texture, or angle of their traction pad, depending on such factors as wave or ocean conditions and desired riding style, however, once a conventional traction pad is affixed onto the surface of the board, it is no longer moveable or repositionable. Further, the adhesive currently used makes traction pads a one-time-use product. Traction pads cannot be removed or interchanged among different boards, such as when a surfer's board breaks and the surfer would like to use the traction pad from the broken board on a different board. Once a conventional traction pad is applied to a board's surface using commonly-used adhesives, the traction pad can only be removed in a painstaking process which results in the traction pad's destruction, rendering it useless for future applications.

Accordingly, what is needed is a traction pad that can be removable and/or moved, or rearranged relative to a board, or which can be dynamically reconfigurable with traction elements such as bevels, bumps, or the like.

### SUMMARY

This document describes a removable traction pad for a board, and a system and a method for removably adhering a traction pad to the board. Instead of having a sole adhesive backing on the traction pad, a traction pad in accordance with implementations described herein incorporate multiple layers, which contains a multiple-use fastening system or connective material. Accordingly, a traction pad as described herein can be used more than once, can be repositionable on a board, and can be transferable from one board to another board, all of which overcomes limitations of conventional one-time-use traction pads.

In accordance with implementations described herein, a traction pad includes a base layer and a traction layer. The base layer is sized and configured to adhere to a top surface of a board. The base layer has a bottom surface that is at least partially provided with an adhesive to permanently affix the base layer to the top surface of the board. The adhesive can include a removable backing, which can be removed to expose the adhesive prior to adherence by the adhesive to the top surface of the board. The base layer further includes a top surface that includes a first portion of a fastening mechanism.

The traction layer has a bottom surface that includes a second portion of the fastening mechanism, which is configured to removably mate, connect, or fasten with the first portion of the fastening mechanism on the top surface of the base layer. The fastening mechanism can be any one of a hook-and-loop fastener, a threaded aperture and screw, a friction fit between one or more receptacles and corresponding protrusions, a mushroom fastener system, or the like. The traction layer further includes a thickness that is sufficient to provide the second portion of the fastening mechanism, as well as a compressibility and pliability to provide suitable or force absorption, and a top surface with one or more traction elements, such as a tail kick, an arch, traction elements, or the like, to provide grip and traction to a rider's foot.

In some aspects, the base layer is preferably a thin material backed with an adhesive that can be glued to the top surface of a board. This part of the traction pad is preferably not removable once placed onto the board. The purpose of the base is to provide a platform with which a fastener system can be engaged. The traction layer can then be applied to the base layer and locked in and engaged to the board, however, the traction layer can be removable and reusable multiple times.

In a particular aspect, a watercraft board traction system includes a base layer having a upper surface and a bottom surface, the bottom surface of the base layer including an adhesive layer configured to adhesively attach to the board. The system further includes a traction layer having an upper surface and a bottom surface, the upper surface of the traction layer having a plurality of traction elements. The system further includes a fastener system having a bottom portion coupled with the upper surface of the base layer and a top portion coupled with the bottom surface of the traction layer, the fastener system being configured to releasably fasten the traction layer to the base layer when the base layer is adhesively attached to the board, the fastener system enabling repositioning and/or reorienting the traction layer relative to the base layer when the traction layer is fastened to the base layer.

In another specific aspect, a watercraft board traction system includes a base layer having a upper surface and a bottom surface, the top surface having a first portion of a fastener, the bottom surface of the base layer including an adhesive layer configured to adhesively attach to the board. The system further includes a traction layer having an upper surface and a bottom surface, the upper surface of the traction layer having a plurality of traction elements, the bottom surface having a second portion of the fastener. The first portion of the fastener is configured to fasten with the second portion of the fastener to releasably fasten the traction layer to the base layer when the base layer is adhesively attached to the board, the fastener enabling repositioning and/or reorienting the traction layer relative to the base layer when the traction layer is releasably fastened to the base layer.

The details of one or more embodiments are set forth in the accompanying drawings and the description below. Other features and advantages will be apparent from the description and drawings, and from the claims.

### BRIEF DESCRIPTION OF THE DRAWINGS

These and other aspects will now be described in detail with reference to the following drawings.

FIGS. 1A and 1B show a traction pad system in accordance with implementations described herein;

FIG. 2 is a cross section of a traction pad system showing a traction layer that mates onto a base layer;

FIGS. 3A and 3B show various alternative edges of a traction layer, as mated onto a base layer;

FIG. 4 illustrates a traction layer having suction members for adhering the traction layer to a top surface of a board, to eliminate the need for a base layer, in accordance with implementations described herein; and

FIGS. 5A and 5B illustrate a multi-piece base layer and corresponding traction layer, in accordance with implementations described herein.

Like reference symbols in the various drawings indicate like elements.

### DETAILED DESCRIPTION

This document describes a traction pad that is removable and repositionable, yet securely attachable to a watercraft board so as to provide immovable traction to a rider of the board.

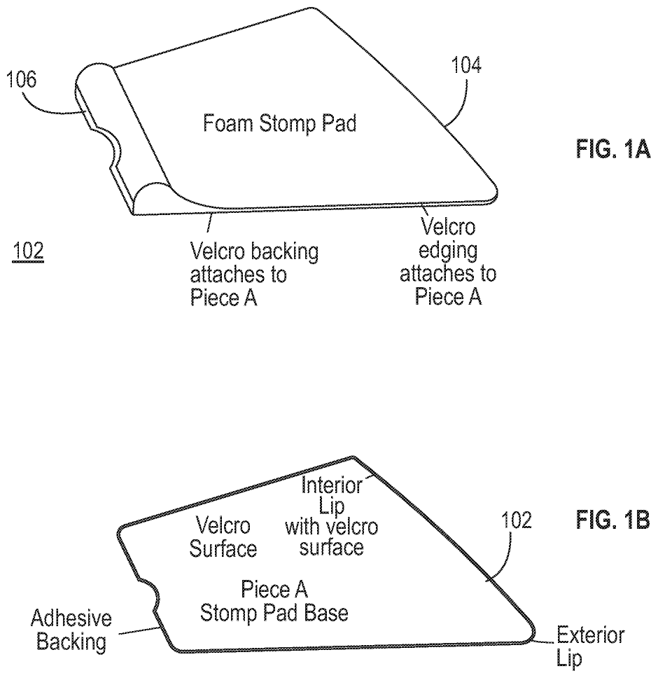

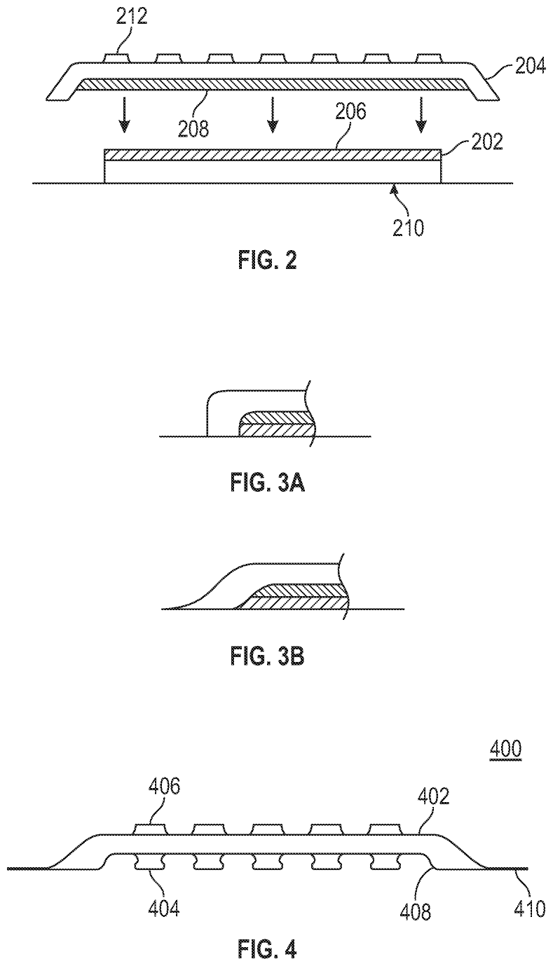

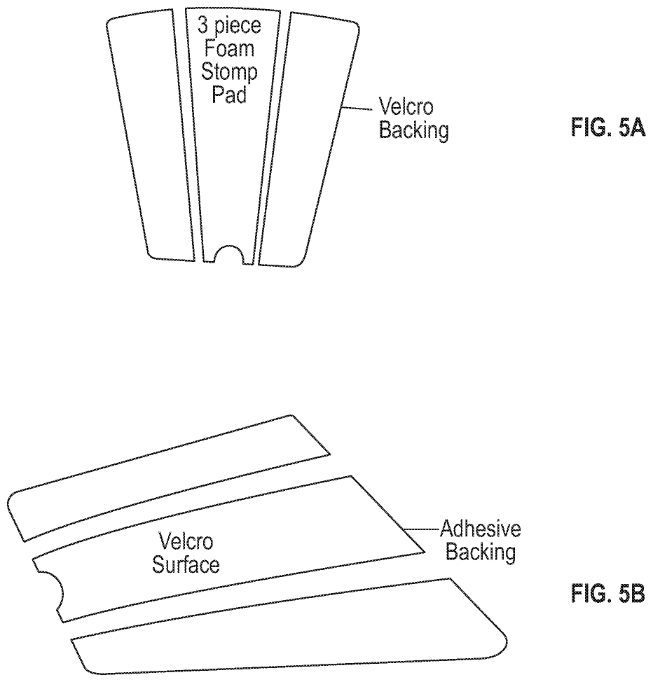

As shown in FIGS. 1-3, a traction pad 100 includes a base layer 102 and a traction layer 104. The base layer is sized and configured to adhere to a top surface of a board. The base layer has a bottom surface that is at least partially provided with an adhesive to permanently affix the base layer to the top surface of the board. The adhesive can include a removable backing, which can be removed to expose the adhesive prior to adherence by the adhesive to the top surface of the board. The base layer further includes a top surface that includes a first portion of a fastening mechanism.

The traction layer 104 has a bottom surface that includes a second portion of the fastening mechanism, which is configured to removably mate, connect, or fasten with the first portion of the fastening mechanism on the top surface of the base layer 102. The traction layer further includes a thickness that is sufficient to provide the second portion of the fastening mechanism, as well as a compressibility and pliability to provide suitable or force absorption, and a top surface with one or more traction elements, such as a kick, an arch, traction elements, or the like, to provide grip and traction to a rider's foot.

In some implementations, a rear bevel 106, also known as a “tail kick” 106, can also be repositionable or reoriented separately on the traction layer 104. For instance, the tail kick 106 can include one or more posts, dowels, cleat, pegs, or the like, that extend downward from an underside of the tail kick 106, and each of which are configured to mate or connect with a corresponding receptacle, hole, aperture, or the like, on the top surface of the traction layer 104. In some implementations, the traction layer 104 can have an array of such receptacles, holes, apertures, or the like, to allow repositioning or reorientation of the tail kick 106 to any desired longitudinal position on the traction layer 104, as well as any desired angular orientation relative to the top surface of the traction layer 104.

In some implementations, a system includes two or more bevels 106 that can be positioned or oriented anywhere on the upper surface of the traction layer 104. For instance, two or more bevels can be positioned and oriented on the traction layer 104 to create a “V” or “U” shaped engagement surface to which a rider can engage with their foot, in order to perform specific movements of the board or specific tricks.

In some implementations, the bottom surface of the traction layer 104 can be inset from, or defined by, lower-extending edges or boundaries. The edges or boundaries of the traction layer 104 can be configured to abut against a top surface of the board, so as to prevent or inhibit water incursion to the fastening system therein. The edges or boundaries can be vertical, angled, or can extend out to a point, as shown in FIGS. 3A and 3B.

The fastening mechanism can include two opposing surfaces to be fastened together, and can be any one or more of a hook-and-loop fastener, a threaded aperture and screw fastener, a friction fit between one or more receptacles and corresponding protrusions, a mushroom fastener system, or the like. For example, the top surface of the base layer 102 can include a number of hooks of a hook-and-loop fastener system, while the bottom surface of the traction layer 104 can include a number of loops of the hook-and-loop fastener system, or vice-versa. Similarly, the top surface of the base layer can include a number of mushroom-shaped protrusions that can mate and fasten with corresponding mushroom-shaped protrusions on the bottom surface of the traction layer. The fastening system can include heavy duty self-engaging mushroom fasteners (such as “Dual Lock®” or “Duotec®”) that feature mushroom-shaped stems on each face of the fastener, providing an audible “snap” when the two faces mate. A strong pressure-sensitive adhesive can bond each component to its respective substrate or layer. Further still, either the base layer 102 or the traction layer 104 can include a number of posts, dowels, cleats or the like, while the other of the base layer 102 or the traction layer 104 can include an array of corresponding receptacles, holes, apertures, or the like.

As described herein, a fastener system can include opposing surfaces to be fastened. The fastener system can be a hook-and-loop fastener, or other type of opposing surface fastener such as a mushroom fastener. As shown in FIG. 4, in some implementations, a fastener system of a traction system 400 need not include two opposing surfaces as above, but can include one or more suction members 404. The traction system includes a traction layer 402, with the one or more suction members 404 on a bottom surface of the traction layer 402, preferably spaced out on the bottom surface. But, the suction members 404 can be arranged on the bottom of the traction layer 402 in any pattern, spacing, or other arrangement.

The suction members 404 can be applied to a top surface of a board, with enough suction so as to render the traction layer 402 mostly immovable on the board, especially in any lateral direction. The traction layer 402 can include edges 408 or boundaries, which can end in an edge point 410 which serves to keep water out of an internal cavity between the edges 408 and the bottom surface of the traction layer 402.

The fastener system can include a hook-and-loop fastener, such as Velcro®, to engage the traction pad with the base, and in turn the board. The traction pad base can be glued to the board with the Velcro® platform facing up, providing the traction pad a surface area with which to engage, connect, or mate. The bottom of the traction pad is accompanied with compatible Velcro®, (i.e. the corresponding layer of the two-layer hook-and-loop or other two-layer faster system) to engage with the base. Once the traction pad is applied to the base it provides the same functions as conventional, permanent adhesive-based traction pads, however it is now removable and reusable. Accordingly, the traction layer can be removed and reapplied to the same board, either in the same or a different orientation, or to a different board. The traction system in accordance with implementations described herein does not have any movement or “give” within the horizontal plane, thus performing how traction pads are meant to perform.

Another variation of a traction system, to ensure no horizontal movement or disengagement of the traction pad from the base layer, is to have the base layer 102 contain a lip around the edges made from the same material as the traction layer 104. The lip can be approximately 1 mm or more in width and substantially the same height as the traction pad 100 (about 2-3 mm). This outer lip of the base layer 102 can essentially be an extension of the traction layer 104 of the traction pad 100 bordering its edges, and serve the purpose to eliminate horizontal movement and prevent the edges of the traction layer 104 from any chances of being pulled up from the base layer 102. The inside walls of the lip on the traction pad base layer 102 can contain a fastener system, as described herein, to engage with the outer walls of the traction pad which would be covered in the compatible component of the fastener system. When engaged, the traction pad and lips/walls of the base can be flush and seemingly one whole surface of the traction pad 100.

Similarly, 3M Dual Lock® materials can provide the same function as Velcro®. The design can be implemented as described above, however the material used to engage the base layer 102 and the traction layer 104 of the traction pad 100 can be substituted for the 3M Dual Lock® material.

In alternative implementations, a fastener system can include one or more snaps, buttons, screws, bolts, or the like, which can be used to apply a traction layer 104 to a watercraft planar surface or a board, or to a base layer 102. As with certain implementations described above, when used with a board, a fastener system can include thin strips backed with adhesive that can be laid down on the board. The side facing up, i.e. a top surface of the base layer 102, can be covered in a studded half of the snaps. The bottom of the traction layer 104 can contain a corresponding pattern of the socket portion of the snaps, allowing the traction pad to engage with the strips glued to the board via the base layer 102. When so engaged, the snaps provide the same support as a traditional adhesive backing, however the traction layer 104 is removable and transferable. As stated above, the design of the base layer when using snaps can also have a lip or wall ensuring the traction pad is held in place in any horizontal or lateral plane.

Magnets are a possible material for application. Thin magnet strips can be backed with adhesives and glued onto the board. Partnering magnets can be built into the traction pad. Neodymium magnets are strong enough to provide pull through other material such as leather. When engaged, the magnetic force would be strong enough to hold the traction pad to the strips which are secured to the board. With the right amount of magnetic force the traction pad would not have any movement in the horizontal plane however enough pull vertically would disengage the traction pad from the magnetic strips, which are secured to the board. This is another way to create a traction pad that is transferable and reusable.

Screwing the traction pad into place can be an application to achieve the goals of having a versatile traction pad. For this method, the construction of the board would have to be changed. The traction pad would have many small screws that would correspond to strategically placed holes in the design of the surfboard to screw the traction pad into place. This can hold the traction pad into place and ensure there would be no movement. Once the pad is unscrewed it can be removed and placed onto a different board, making it a multiple-use object.

Although a few embodiments have been described in detail above, other modifications are possible. Other embodiments may be within the scope of the following claims.

1. A watercraft board traction system comprising
a base layer having a upper surface and a bottom surface, the bottom surface of the base layer including an adhesive layer configured to adhesively attach to the board;
a traction layer having an upper surface and a bottom surface, the upper surface of the traction layer having a plurality of traction elements; and
a fastener system comprising a bottom portion coupled with the upper surface of the base layer and a top portion coupled with the bottom surface of the traction layer, the fastener system being configured to releasably fasten the traction layer to the base layer when the base layer is adhesively attached to the board, the fastener system enabling repositioning and/or reorienting the traction layer relative to the base layer when the traction layer is fastened to the base layer.

2. The system in accordance with claim 1, wherein the fastener system includes one or more hook-and-loop fasteners, with a hook portion of each hook-and-loop fastener provided on either the upper surface of the base layer or the bottom surface of the traction layer, and a loop portion of each hook-and-loop fastener provided on the other of the upper surface of the base layer or the bottom surface of the traction layer.

3. The system in accordance with claim 1, wherein the fastener system includes one or more posts provided on either the upper surface of the base layer or the bottom surface of the traction layer, and a plurality of receptacles provided on the other of the upper surface of the base layer or the bottom surface of the traction layer, each of the receptacles being for receiving one of the one or more posts to reposition and/or reorient the traction layer relative to the base layer.

4. The system in accordance with claim 1, further comprising one or more bevels formed of a material of the traction layer, each of the one or more bevels having an engagement mechanism to engage the traction layer, to allow releasable repositioning and reorienting of each of the one or more bevels.

5. The system in accordance with claim 4, wherein the engagement mechanism includes one or more posts for being inserted into one or more holes in the traction layer.

6. A watercraft board traction system comprising
a base layer having a upper surface and a bottom surface, the top surface having a first portion of a fastener, the bottom surface of the base layer including an adhesive layer configured to adhesively attach to the board; and
a traction layer having an upper surface and a bottom surface, the upper surface of the traction layer having a plurality of traction elements, the bottom surface having a second portion of the fastener;
the first portion of the fastener being configured to fasten with the second portion of the fastener to releasably fasten the traction layer to the base layer when the base layer is adhesively attached to the board, the fastener enabling repositioning and/or reorienting the traction layer relative to the base layer when the traction layer is releasably fastened to the base layer.

7. The system in accordance with claim 6, wherein the fastener system includes one or more hook-and-loop fasteners, with a hook portion of each hook-and-loop fastener provided on either the upper surface of the base layer or the bottom surface of the traction layer, and a loop portion of each hook-and-loop fastener provided on the other of the upper surface of the base layer or the bottom surface of the traction layer.

8. The system in accordance with claim 6, wherein the fastener system includes one or more posts provided on either the upper surface of the base layer or the bottom surface of the traction layer, and a plurality of receptacles provided on the other of the upper surface of the base layer or the bottom surface of the traction layer, each of the receptacles being for receiving one of the one or more posts to reposition and/or reorient the traction layer relative to the base layer.

9. The system in accordance with claim 6, further comprising one or more bevels formed of a material of the traction layer, each of the one or more bevels having an engagement mechanism to engage the traction layer, to allow releasable repositioning and reorienting of each of the one or more bevels.

10. The system in accordance with claim 9, wherein the engagement mechanism includes one or more posts for being inserted into one or more holes in the traction layer.
